(19) United States
(12) Patent Application Publication
(10) Pub. No.: US 2003/0227941 A1
(43) Pub. Date: Dec. 11, 2003

(54) Apparatus and method for converting signal in mobile communication system

(75) Inventor: Won-Seok Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/456,914

(22) Filed: Jun. 9, 2003

(30) Foreign Application Priority Data
Jun. 10, 2002 (KR) 32380/2002

(51) Int. Cl. H04L 12/28

(52) U.S. Cl. 370/467

(57) ABSTRACT

An apparatus for converting signals in a mobile communication system allows a second generation system to perform an IPC test for a third generation system or the third generation to perform the IPC test for the second generation system by communicating between the second generation system and the third generation system.

### BACKGROUND OF THE INVENTION

1. Field of the Invention

The present invention relates to a mobile communication system, and particularly, to an apparatus and a method for converting signals between mobile communication systems of different generations.

2. Background of the Related Art

Mobile communication system can be classified into a first generation mobile communication system transmitting voice signal using an analog frequency modulation (for example, advanced mobile phone service (AMPS)), a second generation mobile communication system such as IS-95 standard mainly transmitting digital voice signal, and a third generation mobile communication system such as IMT-2000 standard that is able to transmit high speed and ultra-high speed data as well as the voice signal as being developed.

Generation shifts in technology and science fields are made gradually, and therefore, a shift into the new system is also made gradually. As a result of the shift, communication between the old and the new systems is inevitable.

An InterProcessor Communication (IPC) is a function supported by the systems so that two processors can communicate with each other, that a processor on one side (processor A) communicates with another processor in the same system (processor B) or with a processor of other system (processor C)/or controls it. Therefore, the processor A transmits a ping signal to the processor C, and grasps IPC path by analyzing returned ping reply signal. The processes of transmitting the ping signal and analyzing the ping reply signal are referred to as ‘IPC test’.

For the IPC test, generally third generation system (hereinafter, referred to as ‘3G system’) uses an ICMP echo request message (hereinafter, referred to as ‘ping’), the second generation system hereinafter, referred to as ‘2G system’) uses an echo request message (hereinafter, referred to as ‘ipclog’), and the IPC tests of the two systems are defined in a standard. However, since the communication between the 2G system and the 3G system is not defined in the standard, the IPC test from the 3G system to the 2G system or from the 2G system to the 3G system can not be performed according to the conventional art.

### SUMMARY OF THE INVENTION

An embodiment of the present provides an apparatus and method for communication between different systems. According to one embodiment, there is provided an apparatus for converting signals in a mobile communication system comprising: a 3G system; a 2G system performing an IPC test with the 3G system; and a signal converting means for converting an IPC test signal of the 3G system into an IPC test signal of the 2G system or converting inversely.

Desirably, the signal converting means is installed on a gateway located between the 3G system and the 2G system. Desirably, the signal converting means comprises a protocol stack including a layer for converting an ICMP and IPoA of the 3G system into IPCLOG of the 2G system or converting inversely; a layer for converting AAL5 of the 3G system into an IPC of the 2G system or converting inversely; and a layer converting an ATM cell of the 3G system into an IPC packet of the 2G system or converting inversely.

In another embodiment, there is provided a method for converting signals in a mobile communication system. The method comprising: a step of receiving an IPC test signal (ping signal) of a 3G system; a step of converting the received ping signal into an IPC test signal (ipclog signal) of a 2G system; a step of transmitting the ipclog signal to a destination processor in the 2G system network; a step of receiving ipclog reply signal from the destination processor; a step of converting the received ipclog reply signal into an IPC test response signal (ping reply signal) of the 3G system; and a step of transmitting the generated ping reply signal to the source of the ping signal.

In another embodiment, there is provided a method for converting signals in a mobile communication system comprising: a step of receiving an IPC test signal (ipclog signal) of a 2G system; a step of converting the receive ipclog signal into an IPC test signal (ping signal) of a 3G system; a step of transmitting the ping signal to a destination processor in the 3G system network; a step of receiving a ping reply signal from the destination processor; a step of converting the received reply signal into an IPC test response signal (ipclog reply signal) of the 2G system; and a step of transmitting the generated ipclog reply signal to the ipclog signal source. Desirably, the step of converting the ipclog signal into the ping signal comprises: a step of converting the IPCLOG of the 2G system into an ICMP and an IPoA of the 3G system; a step of converting an IPC of the 2G system into an AAL5 of the 3G system; and a step of converting an IPC packet of the 2G system into an ATM cell of the 3G system. Desirably, the step of converting the ping reply signal into an ipclog reply signal comprises: a step of converting the ICMP and the IPoA of the 3G system into the IPCLOG of the 2G system; a step of converting the AAL5 of the 3G system into the IPC of the 2G system; and a step of converting the ATM cell of the 3G system into the IPC packet of the 2G system.

Additional advantages, and features of the invention will be set forth in part in the description which follows and in part will become apparent to those having ordinary skill in the art upon examination of the following or may be learned from practice of the invention. The advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing a mobile communication system according to an embodiment of the present invention;

FIG. 2 is a flow chart of a signal for performing an IPC test according to an embodiment of the present invention;

FIG. 3 is a view showing a 2G system, a protocol converter and a protocol stack of a 3G system according to an embodiment of the present invention; and

FIG. 4 is a view showing a data unit configuration of respective layers shown in FIG. 3.

### DETAILED DESCRIPTION OF PREFERRED EMBODIMENTS

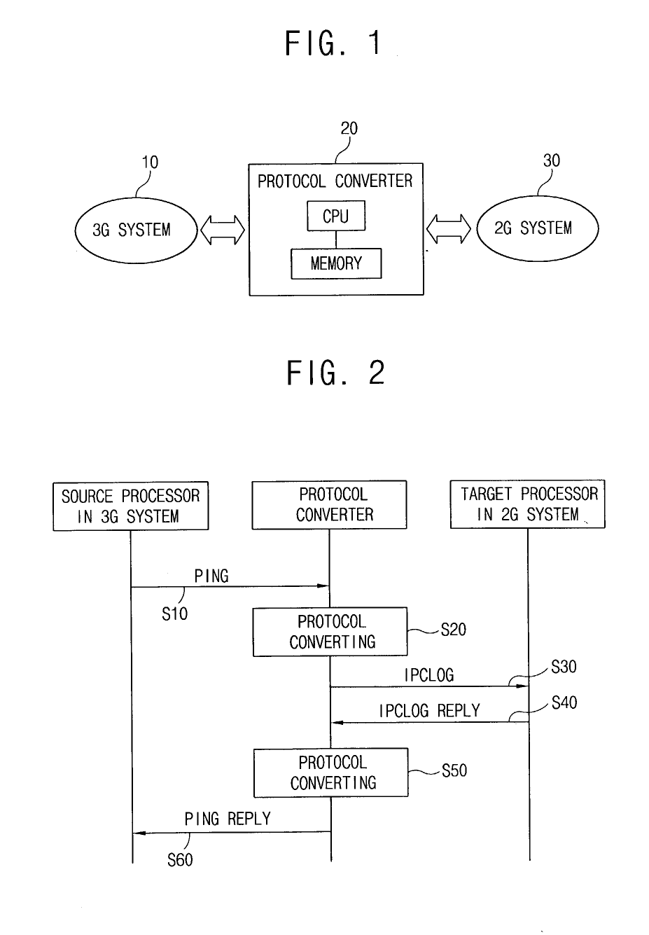

The present invention provides a method for communicating between two systems so that a 3G system (or 2G system) performs an IPC test toward a 2G system (or 3G system). As shown in the FIG. 1 embodiment, the mobile communication system comprises: a 3G system 10; a 2G system 30 performing an IPC test with the 3G system 10; and a protocol converter 20 for converting an IPC test signal of the 3G system into an IPC test signal of the 2G system or for converting inversely.

The protocol conversion means that information except source data (for example, header, etc.) among the components of a signal going toward a destination system (for example, IPC packet, ATM cell, etc.) is converted into the form suitable for the destination system. The protocol converter 20 performs the protocol conversion for communicating between the two systems 10 and 30, and comprises a predetermined memory required for the protocol conversion and a CPU controlling the memory.

FIG. 2 is a flow chart of a signal for performing the IPC test, and shows the IPC test performed from the 3G system to the 2G system. In order to perform the IPC test, the 3G system 10 generates an IPC test signal (hereinafter, referred to as ‘ping signal’), and transmits the generated ping signal to the protocol converter 20 (S10). The protocol converter 20 converts the protocol of the received ping signal to generate an IPC test signal of the 2G system (hereinafter, referred to as ‘ipclog signal’) (S20), and transmits the generated ipclog signal to a destination processor in the 2G system network (S30).

On receiving the ipclog signal, the 2G system 30 generates a response signal of the IPC test signal (hereinafter, referred to as ‘ipclog reply signal’) and transmits it to the protocol converter 20 (S40), and the protocol converter 20 converts the protocol of the received ipclog reply signal to generate a response signal of the IPC test signal (hereinafter, referred to as ‘ping reply signal’) of the 3G system (S50) and transmits the generated ping reply signal to the ping signal source (S60). Since the 3G system has an ATM based network configuration, the protocol of the ping signal should be converted (ATM cell→IPC packet) and address mapping is performed in order to transmit the ping signal to the 2G system network 20. The above operations are performed by the protocol converter 20 installed on a gateway 21.

When passing through the gateway 21, the ping signal is converted into the ipclog signal and the transmission type of the ping signal is converted from the ATM cell into the IPC packet, and then, the signal is transmitted into the 2G system 30. In addition, the ipclog signal transmitted to the 2G system 30 is transmitted to the destination processor according to the IPC test procedures of the 2G system 30.

The destination processor receiving the ipclog signal generates a predetermined response signal (ipclog reply signal) and sends the signal to the ping signal source (S30). The ipclog reply signal sent from the 2G system 30 is transmitted to the 3G system 10 after passing through the gateway 21. The gateway 21 converts the ipclog reply signal to the ping reply signal, and also converts the signal transmission type (IPC packet) to the ATM cell.

In addition, when the ping reply signal is received, the 3G system 10 delivers the signal to the ping signal source according to the IPC test procedures of the 3G system 10 (S40). In above process S20, when the ping signal of the 3G system is converted into the ipclog signal, the ipclog signal processing in the 2G system is performed according to the IPC test procedures of the 2G system. The IPC test performed from the 2G system 30 to the 3G system 10 to the reverse direction of the signal flow shown in FIG. 2.

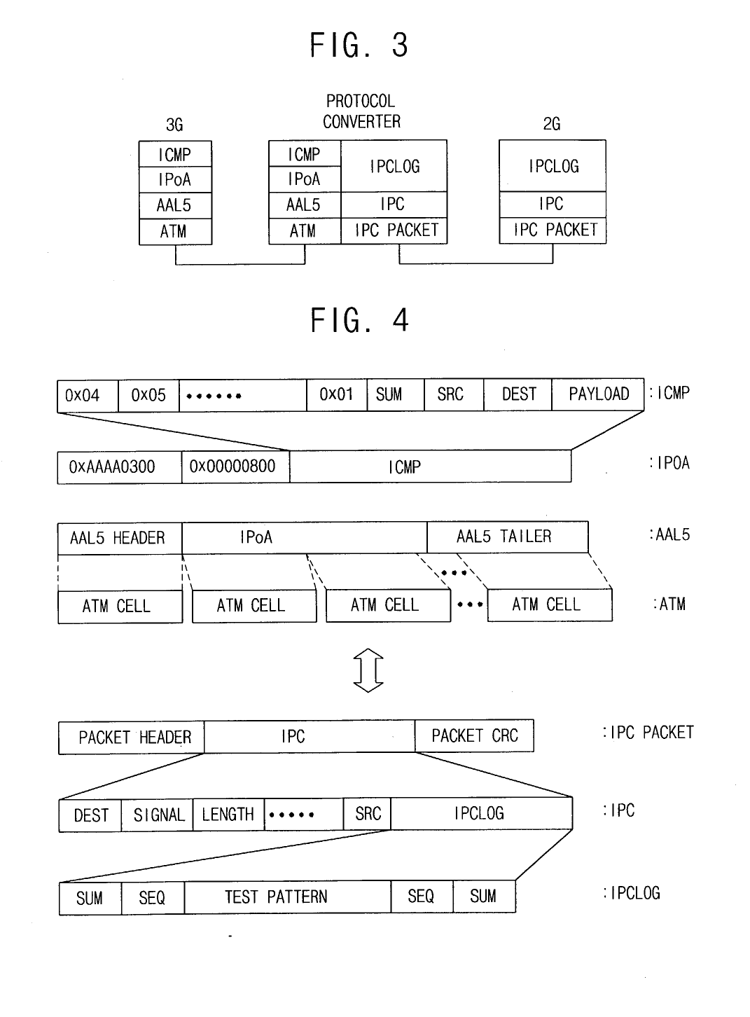

FIG. 3 is a view showing the 2G system, the protocol converter and a protocol stack of the 3G system. As shown therein, the protocol stack of the 3G system 10 comprises a layer for performing internet control message protocol (ICMP), a layer for performing IP over ATM (IPoA), a layer for performing ATM adaptation layer 5 (AAL5), and a layer for generating asynchronous transfer mode (ATM) cell. And the protocol stack of the 2G system 30 comprises a layer for performing inter processor communication LOG (IPCLOG), a layer for performing inter processor communication (IPC), and a layer for generating the IPC packet.

The IPoA is a definition about procedures for communicating between IP hosts in one logical IP subnet (LIS) directly using the ATM network and an address converting method, and an essential content of the IPoA is an address conversion for converting the IP address into the ATM address. The ICMP is a protocol for controlling a message and error notification between a host server and an internet gateway and defined on RFC 792. When the ping signal performs the IPC test or the internet connection test, the ICMP is used.

When the IPC test signal (ping signal) of the 3G system is converted into the IPC test signal (ipclog signal) of the 2G system, the ICMP and IPoA of the ping signal are converted into the IPCLOG, the AAL5 of the ping signal is converted into the IPC, and the ATM cell of the ping signal is converted into the IPC packet. In contrast, when the IPC test response signal (ipclog reply signal) of the 2G system is converted into the IPC test response signal (ping reply signal) of the 3G system, the IPCLOG of the ipclog reply signal is converted into the ICMP and IPoA, the IPC of the ipclog reply signal is converted into the AAL5, and the IPC packet of the ipclog reply signal is converted into the ATM cell.

FIG. 4 is a view showing data unit configurations of the respective layers shown in FIG. 3. As described above, the mobile communication system according to an embodiment of the present invention is realized so that the second generation system is able to perform the IPC test for the third generation system or the third generation system is able to perform the IPC test for the second generation system by communicating between the second generation system and the third generation system.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus for converting signals in a mobile communication system comprising:
a third generation (3G) system;
a second generation (2G) system; and
a signal converting device to convert one of a first IPC test signal of the 3G system into a first IPC test signal of the 2G system and a second IPC test signal of the 2G system into a second IPC test signal of the 3G system.

2. The apparatus of claim 1, wherein the signal converting device is in a gateway between the 3G system and the 2G system.

3. The apparatus of claim 1, wherein the 3G system has a protocol stack comprising:
a layer for performing an internet control message protocol (ICMP);
a layer for performing an ATM based internet protocol (IP over ATM);
a layer for performing an AAM adaptation layer 5 (AAL5); and
a layer for generating an asynchronous transfer mode (ATM) cell.

4. The apparatus of claim 1, wherein the 2G system has a protocol stack comprising:
a layer for performing an inter processor communication LOG (IPCLOG);
a layer for performing an inter processor communication (IPC); and
a layer for generating an IPC packet.

5. The apparatus of claim 1, wherein the signal converting device has a protocol stack comprising:
a layer for converting an ICMP and an IPoA of the 3G system into an IPCLOG of the 2G system;
a layer for converting an AAL5 of the 3G system into an IPC of the 2G system; and
a layer for converting an ATM cell of the 3G system into an IPC packet of the 2G system.

6. The apparatus of claim 1, wherein the signal converting device has a protocol stack comprising:
a layer for converting an IPCLOG of the 2G system into an ICMP and an IPoA of the 3G system;
a layer for converting an IPC of the 2G system into an AAL5 of the 3G system; and
a layer for converting an IPC packet of the 2G system into an ATM cell of the 3G system.

7. The apparatus of claim 1, wherein the signal converting device is adapted to:
convert an ICMP and an IPoA of the 3G system into an IPCLOG of the 2G system;
convert an AAL5 of the 3G system into an IPC of the 2G system; and
convert an ATM cell of the 3G system into an IPC packet of the 2G system.

8. The apparatus of claim 1, wherein the signal converting device is adapted to:
convert an IPCLOG of the 2G system into an ICMP and an IPoA of the 3G system;
convert an IPC of the 2G system into an AAL5 of the 3G system; and
convert an IPC packet of the 2G system into an ATM cell of the 3G system.

9. A method for converting signals in a mobile communication system comprising:
receiving an IPC test signal (ping signal) of a 3G system;
converting the received ping signal into an IPC test signal of a 2G system (ipclog signal);
transmitting the ipclog signal to a destination processor in the 2G system network;
receiving an ipclog reply signal from the destination processor;
converting the received ipclog reply signal into an IPC test response signal of the 3G system (ping reply signal); and
transmitting the generated ping reply signal a ping signal source.

10. The method of claim 9, wherein the 3G system has a protocol stack comprising:
a layer for performing an internet control message protocol (ICMP);
a layer for performing an ATM based internet protocol (IP over ATM);
a layer for performing an AAM adaptation layer 5 (AAL5); and
a layer for generating an asynchronous transfer mode (ATM) cell.

11. The method of claim 9, wherein the 2G system has a protocol stack comprising:
a layer for performing an inter processor communication LOG (IPCLOG);
a layer for performing an inter processor communication (IPC); and
a layer for generating an IPC packet.

12. The method of claim 9, wherein converting the ping signal into the ipclog signal comprises:
converting an ICMP and an IPoA of the 3G system into an IPCLOG of the 2G system;
converting an AAL5 of the 3G system into an IPC of the 2G system; and
converting an ATM cell of the 3G system into an IPC packet of the 2G system.

13. The method of claim 9, wherein converting the ipclog reply signal into the ping reply signal comprises:
converting an IPCLOG of the 2G system into an ICMP and an IPoA of the 3G system;
converting an IPC of the 2G system into an AAL5 of the 3G system; and
converting an IPC packet of the 2G system into an ATM cell of the 3G system.

14. A method for converting signals in a mobile communication system comprising:
receiving an IPC test signal (ipclog signal) of a 2G system;
converting the received ipclog signal into an IPC test signal (ping signal) of a 3G system;
transmitting the ping signal to a destination processor in the 3G system;
receiving a ping reply signal from the destination processor;
converting the received ping reply signal into an IPC test response signal (ipclog reply signal) of the 2G system; and
transmitting the generated ipclog reply signal to a ipclog signal source.

15. The method of claim 14, wherein the 3G system has a protocol stack comprising:
a layer for performing an internet control message protocol (ICMP);
a layer for performing an ATM based internet protocol (IP over ATM);
a layer for performing an AAM adaptation layer 5 (AAL5); and
a layer for generating an asynchronous transfer mode (ATM) cell.

16. The method of claim 14, wherein the 2G system has a protocol stack comprising:
a layer for performing an inter processor communication LOG (IPCLOG);
a layer for performing an inter processor communication (IPC); and
a layer for generating an IPC packet.

17. The method of claim 14, wherein converting the ipclog signal into the ping signal comprises:
converting an IPCLOG of the 2G system into an ICMP and an IPoA of the 3G system;
converting an IPC of the 2G system into an AAL5 of the 3G system; and
converting an IPC packet of the 2G system into an ATM cell of the 3G system.

18. The method of claim 14, wherein converting the ping reply signal into the ipclog reply signal comprises:
converting an ICMP and an IPoA of the 3G system into an IPCLOG of the 2G system;
converting an AAL5 of the 3G system into an IPC of the 2G system; and
converting an ATM cell of the 3G system into an IPC packet of the 2G system.

19. A method of communication between a 3G system and a system comprising;
converting a first signal from one of the BG and 2G system to a second signal of one of the 2G and 3G and the 2G communicate with one another.

20. A method of communication between a 3G system and a 2G system comprising converting a first signal from one of the 3G system and the 2G system to a second signal of one of the 2G system and the 3G system, respectively, such that the 3G system and the 2G system communicate with one another.
